(19) United States
(12) Patent Application Publication
(10) Pub. No.: US 2025/0086678 A1
(43) Pub. Date: Mar. 13, 2025

(54) DESIGN CREATION SUPPORT APPARATUS, DESIGN CREATION SUPPORT METHOD, AND DESIGN CREATION SUPPORT PROGRAM

(71) Applicant: KONICA MINOLTA, INC., Tokyo (JP)

(72) Inventors: Shoichi URATANI, Tokyo (JP); Satoru INOUE, Tokyo (JP); Nobuhiko TAKASHIMA, Tokyo (JP); Kenji TERADA, Tokyo (JP); Shinichiro SAITO, Tokyo (JP); Rieko TAKAHASHI, Tokyo (JP); Mayumi MATSUDA, Tokyo (JP)

(21) Appl. No.: 18/564,937

(22) PCT Filed: Mar. 11, 2022
(86) PCT No.: PCT/JP2022/010827

§ 371 Date: Nov. 28, 2023

(30) Foreign Application Priority Data
Jun. 2, 2021 (JP) 2021-092732

(51) Int. Cl. G06Q 30/0241; G06Q 30/0251

(52) U.S. Cl. CPC G06Q 30/0276; G06Q 30/0255

(57) ABSTRACT

To provide, for a user who has little knowledge about advertisement design, a design creation support apparatus, a design creation support method, and a design creation support program that support design creation of an advertisement. A design creation support apparatus that supports design creation of a design object including an advertisement or a publication includes input information acquisition sections and, a design information generation section, and output sections and. The input information acquisition sections and acquire input information including a purpose of the design object. The design information generation section generates design information that includes information related to design of the design object, based on a behavioral economic background determined according to the input information. The output sections and output the design information generated by the design information generation section.

### TECHNICAL FIELD

The present invention relates to a design creation support apparatus, a design creation support method, and a design creation support program.

### BACKGROUND ART

The design of advertisements for products, services, or the like is an important factor in capturing consumer interest in the market. Sellers have conventionally implemented image strategy to capture consumer interest, leading to product purchase.

When a seller advertises a product or a service, the seller sometimes outsources design creation of the advertisement, but there are also cases where the seller itself creates design of the advertisement due to a balance between costs involved in the design creation, the deadline, the quality, and the like. However, it is difficult for a seller who has little knowledge about advertisement design to create an advertisement effective for sales promotion, and a burden on work is large.

In this regard, the following Patent Literature 1 discloses an information processing apparatus including a function of managing templates (model data) for creating an editing material such as a flyer and an advertisement and providing a template in response to a request. This apparatus extracts content (background content, image content, character string content, and the like) from an input document, determines the taste of its content, and selects a template.

In addition, the following Patent Literature 2 discloses a screen expression evaluation apparatus that evaluates, for individual components, whether or not the conspicuousness of the component matches the importance of the component when viewed on the entire screen. This apparatus evaluates the conspicuousness of the component based on combinations of expression information indicating the feature of the expression applied to the component and an importance degree indicating the degree of the importance of the component on a target screen.

### CITATION LIST

### Patent Literature

Patent Literature 1: JP 6623603 B2
Patent Literature 2: JP 6186754 B2

### SUMMARY OF INVENTION

### Technical Problem

Unfortunately, in the apparatus of Patent Literature 1, there is an issue in which it is difficult for a seller who has little knowledge about advertisement design to input an appropriate document.

In addition, the apparatus of Patent Literature 2 includes a technique for evaluating the conspicuousness of components, not a technique for supporting design creation, so that there is an issue in which it is not possible to know what kind of components should be specifically used.

The present invention has been made in view of the above issues. Therefore, an object of the present invention is to provide, for a user who has little knowledge about advertisement design, a design creation support apparatus, a design creation support method, and a design creation support program that support design creation of an advertisement. Here, the user is a person who actually uses the design creation support apparatus.

### Solution to Problem

The above-described issues of the present invention are solved by the following means.

(1) A design creation support apparatus for supporting design creation of a design object including an advertisement or a publication, the design creation support apparatus including an input information acquisition section that acquires input information including a purpose of the design object, a design information generation section that generates design information that includes information related to design of the design object based on a behavioral economic background determined according to the input information, and an output section that outputs the design information generated by the design information generation section.

(2) The design creation support apparatus according to the above-mentioned (1), in which the output section includes a design plan presentation section that generates a design plan of the design object based on the design information, and a display section that displays the design plan of the design object.

(3) The design creation support apparatus according to the above-mentioned (1) or (2), in which the input information acquisition section further acquires, as the input information, at least any of an approach of the design object, a target audience for appeal, an image to be inserted into the design object, and an applied medium.

(4) The design creation support apparatus according to the above-mentioned (3), in which the applied medium includes a print medium and a digital medium.

(5) The design creation support apparatus according to any one of the above-mentioned (1) to (4), in which the behavioral economic background is at least any of bandwagon effect, Zajonc effect, Veblen effect, halo effect, Windsor effect, loss aversion, priming effect, confirmation bias, anchoring effect, status quo bias, endowment effect, scarcity, Zinc pyrithione effect, authority, favor, social proof, consistency, reciprocity, intellectual curiosity, application of affordance, MAYA principle, paradox of choice, undermining, gamification, and prospect theory.

(6) The design creation support apparatus according to the above-mentioned (5), further including a database that stores therein a behavioral economic background corresponding to the purpose of the design object and a behavioral economics determination section that searches for, using the database, the behavioral economic background corresponding to the purpose of the design object and determines a behavioral economic background to be applied.

(7) The design creation support apparatus according to the above-mentioned (6), in which the behavioral economics determination section interprets a text content of the purpose of the design object and determines the behavioral economic background to be applied based on an interpretation result.

(8) The design creation support apparatus according to the above-mentioned (6) or (7), in which the design information generation section selects a catchphrase of the design object based on the background that is determined and generates the design information including the catchphrase and display layout of the catchphrase.

(9) The design creation support apparatus according to the above-mentioned (5), further including a background selection section with which a user selects the behavioral economic background that is to be applied, in which the design information generation section selects a catchphrase of a design object based on the background that is selected and generates the design information including the catchphrase and display layout of the catchphrase.

(10) The design creation support apparatus according to the above-mentioned (2), further including a design physical quantity calculation section that calculates a physical quantity related to display of the design plan.

(11) The design creation support apparatus according to the above-mentioned (10), in which the physical quantity includes at least any of a conspicuous degree and a hue.

(12) The design creation support apparatus according to the above-mentioned (10), in which the design information generation section generates display layout for displaying, on an identical screen, the purpose of the design object, the catchphrase of the design object, the image to be inserted into the design object, the behavioral economic background corresponding to the purpose of the design object, and the physical quantity, and the output section displays, on an identical screen, the purpose of the design object, the catchphrase of the design object, the image to be inserted into the design object, the behavioral economic background corresponding to the purpose of the design object, and the physical quantity.

(13) The design creation support apparatus according to any one of the above-mentioned (1) to (12), further including a result reception section that receives a conversion of a campaign of a design object corresponding to the purpose of the design object.

(14) A design creation support method for supporting design creation of a design object, the design creation support method including a step (a) of acquiring input information including a purpose of the design object, a step (b) of generating design information that includes information related to design of the design object based on a behavioral economic background determined according to the input information, and a step (c) of outputting the design information generated in the step (b).

(15) A design creation support program for causing a computer to execute processing included in the design creation support method according to the above-mentioned (14).

### Advantageous Effects of Invention

According to the present invention, the design information that includes the information related to design of the design object, is generated and output based on the behavioral economic background determined according to the input information including the purpose of the design object. Therefore, it is possible to support design creation even in a case where the user has little knowledge about design of the design object.

### BRIEF DESCRIPTION OF DRAWINGS

FIG. 1 is a block diagram illustrating a schematic hardware configuration of a design creation support apparatus.

FIG. 2 is a functional block diagram illustrating main functions of a controller illustrated in FIG. 1.

FIG. 3A is a flowchart illustrating a design creation support method of the design creation support apparatus according to a first embodiment.

FIG. 3B is a subroutine flowchart for describing details of step S102 in FIG. 3A.

FIG. 4A is a schematic diagram illustrating a design plan including a catchphrase for men in their thirties.

FIG. 4B is a schematic diagram illustrating a design plan including a catchphrase for men in their sixties.

FIG. 5A is a schematic diagram illustrating a design plan in a case where a behavioral economic background to be applied is reciprocity.

FIG. 5B is a schematic diagram illustrating a design plan in the case where a behavioral economic background to be applied is scarcity.

FIG. 5C is a schematic diagram illustrating a design plan in the case where a behavioral economic background to be applied is the bandwagon effect.

FIG. 6 is a schematic diagram illustrating a screen configuration in a design creation support apparatus of a second embodiment.

FIG. 7 is a diagram indicating an example of an inquiry rate for each catchphrase of an advertisement and each dissemination destination persona.

FIG. 8 is a diagram indicating an example of estimated amounts of advertising expense and sales loss in cases where an advertisement is disseminated and is not disseminated.

FIG. 9 is a diagram indicating an example of expected loss amounts and results of determining whether or not to disseminate an advertisement in cases where an advertisement is disseminated and is not disseminated.

### DESCRIPTION OF EMBODIMENTS

Hereinafter, embodiments of the present invention will be described with reference to the drawings. Note that in the drawings, the same elements are denoted by the same reference signs, and redundant description thereof will be omitted. In addition, dimensional ratios in the drawings are exaggerated for convenience of description and may be different from actual ratios.

### First Embodiment

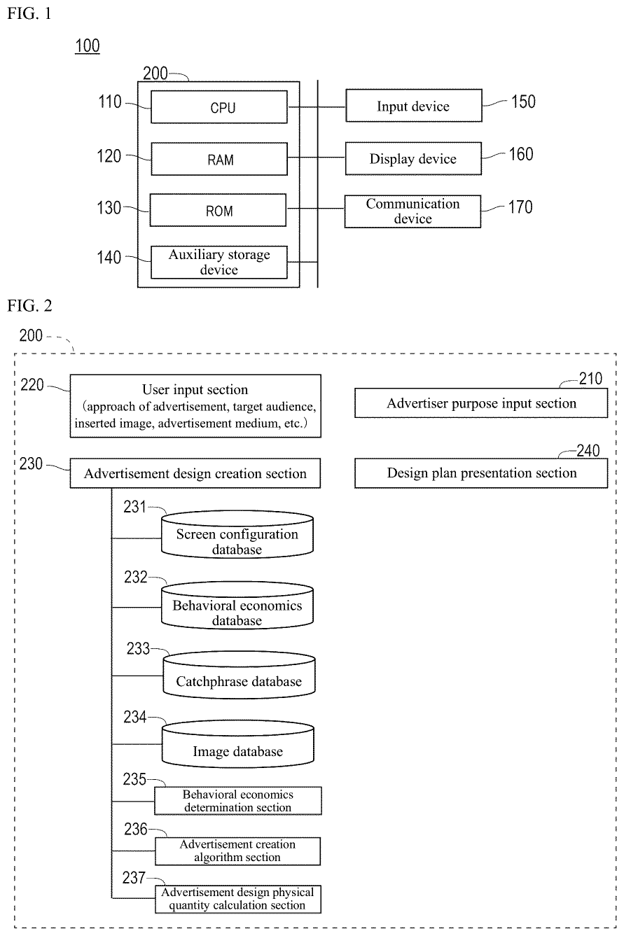

FIG. 1 is a block diagram illustrating a schematic hardware configuration of a design creation support apparatus. A design creation support apparatus 100 according to the first embodiment is an apparatus that presents, to a user, catchphrases and/or design plans of advertisements of products, services, and the like, thereby supporting design creation of advertisements. Note that hereinafter, a case where the design creation support apparatus 100 mainly supports the design creation of advertisements will be described. However, the design creation support apparatus 100 may be configured to support not only the design creation of advertisements, but also the design creation of design objects including publications (for example, magazines and the like). In this case, the design creation support apparatus 100 can also be used for the design creation of cover sheets of magazines and the like, for example.

The advertisement medium (applied medium) may be a print medium and a digital medium. The print medium may be, for example, a paper print medium for advertising by printing information on paper, such as paper flyers. Alternatively, the print medium may be a medium for advertising with printed material other than paper. Meanwhile, the digital medium may be, for example, web flyers displayed on a personal computer or a smartphone. in addition, the user is a user (operator) of the design creation support apparatus 100, and may be an advertiser (for example, a seller of a product or a service to be targeted for the advertisement) itself, a corporation such as an advertising company and the like, and an advertising designer that are requested to create an advertisement by the advertiser, and the like. In addition, the user may be, for example, a person who creates a sample of advertisement design as part of a sales process (for example, a sales representative of a printing company). It is assumed that many of advertisers, sales representatives, and the like have little knowledge about advertisement design.

The design creation support apparatus 100 may be a personal computer, a smartphone, a personal digital assistant (PDA), a tablet terminal, and the like in which a design creation support program that is described below is installed.

As illustrated in FIG. 1, the design creation support apparatus 100 includes a central processing unit (CPU) 110, a random access memory (RAM) 120, a read only memory (ROM) 130, an auxiliary storage device 140, an input device 150, a display device 160, and a communication device 170. Among these, the central processing unit (CPU) 110, the random access memory (RAM) 120, the read only memory (ROM) 130, and the auxiliary storage device 140 constitute a controller 200.

The CPU 110 executes an operating system (OS) and a design creation support program deployed in the RAM 120 to perform operation control of the input device 150, the display device 160, and the communication device 170. The RAM 120 stores therein date and the like temporarily generated through processing of the CPU 110. The ROM 130 stores therein programs to be executed by the CPU 110, data, and parameters to be used for the execution of the programs, and the like. The auxiliary storage device 140 includes, for example, a hard disk drive (HDD) and a solid state drive (SSD), and stores programs therein.

The input device 150 includes, for example, a keyboard, a mouse, and the like, and is used for the user to perform various instructions (inputs) such as character input and various settings using the keyboard, the mouse, and the like. In the present embodiment, it is used for input of a purpose and an approach (aim) of an advertisement and the like.

The display device 160 includes a display that functions as a display section to display a design plan of the advertisement, information that is input or set by the user, and the like.

The communication device 170 includes, for example, a communication circuit such as a network interface card (NIC) to perform data transmission with an external device through a communication network (not illustrated).

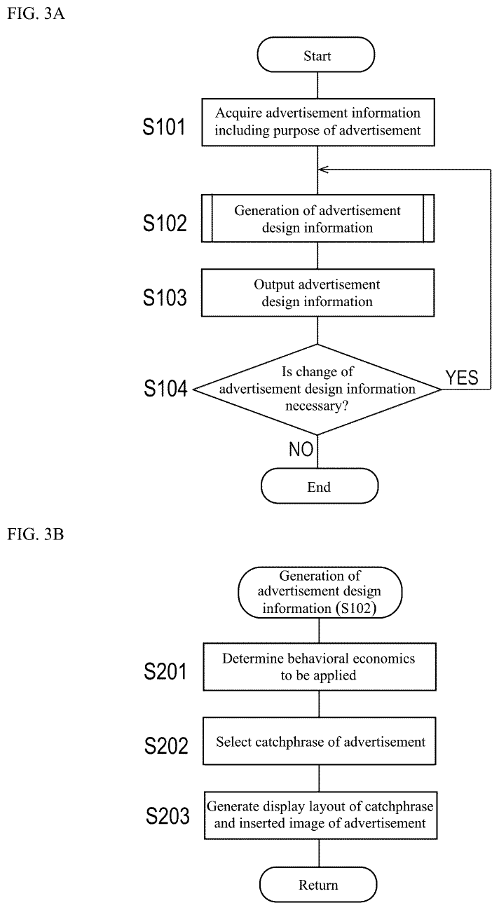

FIG. 2 is a functional block diagram illustrating main functions of the controller 200 illustrated in FIG. 1. The controller 200 functions as an advertiser purpose input section 210, a user input section 220, an advertisement design creation section 230, a screen configuration database 231, a behavioral economics database 232, a catchphrase database 233, and an image database 234. In addition, the controller 200 functions as a behavioral economics determination section 235, an advertisement creation algorithm section 236, an advertisement design physical quantity calculation section 237, and a design plan presentation section 240. These functions are implemented by the CPU 110 executing the design creation support program. The advertiser purpose input section 210 and the user input section 220 constitute an input information acquisition section.

The advertiser purpose input section 210 acquires a purpose of an advertisement (design object) by an advertiser (brand owner). The advertiser may be, for example, a seller of a product or a service. Examples of the purpose of the advertisement include “Creating Favorable Perception”, “Generating New Need”, “Making It Look Attractive”, and the like. The user inputs the purpose of the advertisement using the input device 150, for example. In a case where a plurality of the purposes of the advertisement are input, the advertiser purpose input section 210 acquires the plurality of purposes of the advertisement.

The user input section 220 acquires advertisement information (input information) related to an approach of the advertisement, a target audience, an image to be inserted into the advertisement (hereinafter, referred to as an “inserted image”), an advertisement medium, and the like. The user can input the advertisement information using the input device 150. The approach of the advertisement is a viewpoint and a measure for achieving the purpose of the advertisement. Specific examples of the approach of the advertisement will be described below.

The target audience, which is a target audience for appeal, is a group of individuals belonging to, for example, the target age, sex, annual income, residential area, and the like to which advertising appeal is directed.

The inserted image is, for example, an image related to a product or a service, and is useful for readers of the advertisement to understand a concept or content of the product or the service. The user input section 220 acquires the inserted image through user input or acquires the inserted image from an external server via the communication device 170 to store the inserted image in the image database 234. In addition, the advertisement medium may be, for example, a print medium, a digital medium, and the like.

The auxiliary storage device 140 functions as the screen configuration database 231, the behavioral economics database 232, the catchphrase database 233, and the image database 234.

The screen configuration database 231 stores therein data related to an advertisement configuration. The data related to the advertisement configuration may include, for example, a plurality of types of components (for example, inserted images, tables, and like) and a plurality of templates that specifies display layout of the components that correspond to the purpose and approach of the advertisement.

The behavioral economics database 232 stores therein effects, properties, theories, and the like based on the behavioral economics (hereinafter, simply referred to as “behavioral economics” or “behavioral economic background” in the present specification) corresponding to the advertisement information. As illustrated in Table 1 below, in the behavioral economics database 232, the behavioral economics is preset according to, for example, the purpose and approach of the advertisement.

TABLE 1

| Purpose of advertisement | Approach of advertisement | Behavioral economic background |
|---|---|---|
| Creating favorable | Hiring influencer as brand ambassador | Bandwagon effect (reviews from many people) |
| perception | Recognizable design | Bandwagon effect (reviews from many people) |
| | | Veblen effect (people's desire to present version |
| | | of themselves after making purchase) |
| | Taking advantage of powerful partner | Zajonc effect (pairing with partner who has |
| | | already favorable perception and frequent |
| | | exposure) |
| | Relating it to social topic | Halo effect (getting positive impression by |
| | | conspicuous feature) |
| | Information dissemination by fans | Windsor effect (people's tendency to trust talk |
| | | of third-party compared with hearing from |
| | | person directly) |
| Generating new need | Forcibly bringing risk to mind | Loss aversion (people overreact to risk of losing |
| | | compared with gaining) |
| | Introducing new enemy | Loss aversion |
| | New custom | Priming effect (influence of information given |
| | | in advance) |
| | Providing good excuse | Confirmation bias (people's tendency to gather |
| | | material that justify their belief) |
| | Element of milestone | Anchoring effect (anchoring specific timing) |
| | | Status quo bias (avoiding procrastinating mind) |
| | Allowing people to possess product | Endowment effect (people value possessed |
| | first | product higher than usual and want to keep it) |
| | Trying to get as close as possible | Zajonc effect (mere-exposure effect) |
| Making it look attractive | Striving to be number one | Bandwagon effect (reviews from many people) |
| | | Halo effect (getting positive impression by |
| | | conspicuous feature) |
| | Achieving sense of rarity | Scarcity (considering it as valuable) |
| | | Endowment effect |
| | Stuff that seems good but is unknown | Zinc pyrithione effect (hasty judgment by |
| | | somehow considering stuff as good based on |
| | | impressive-sounding word) |
| | Story for creating empathy | Priming effect (influencing positively by story |
| | | given in advance) |
| | Third party recommendation | Windsor effect |

The behavioral economics may include, for example, the bandwagon effect, the Zajonc effect, the Veblen effect, the halo effect, the Windsor effect, loss aversion, the priming effect, the confirmation bias, the anchoring effect, the status quo bias, the endowment effect, scarcity, and the Zinc pyrithione effect. In addition, the behavioral economics may include authority, favor, social proof, consistency, reciprocity, intellectual curiosity, application of affordance, MAYA principle, the paradox of choice, undermining, gamification, and prospect theory. Note that these theories of the behavioral economics are known in the field to which so-called those skilled in the art belong, so that detailed description thereof will be omitted.

The catchphrase database 233 stores therein a large number of catchphrase candidates related to various products and services. One or more catchphrase candidates are included for the combination of the purpose of the advertisement, the approach of the advertisement, and the behavioral economics. Table 2 below indicates examples of the catchphrase candidates in a case where the purpose of the advertisement is “Generating New Need”, the approach is “Forcibly Bringing Risk To Mind”, and the behavioral economics is “Loss Aversion”.

TABLE 2

| Purpose of advertisement | Approach of advertisement | Behavioral economics | Candidate of catchphrase |
|---|---|---|---|
| Generating new need | Forcibly bringing risk to | Loss aversion | New launch in Japan, limited stock |
| | mind | | items. Don't miss it! |
| | | | If item doesn't fit right, you can |
| | | | exchange it for free! |
| | | | Smoking increases risk of cancer |
| | | | development. Allow us to introduce |
| | | | new smoking separation product. |

The image database 234 stores therein a large number of images corresponding to components of the print surface of the print medium (or a screen of the digital medium or the like). The image may be, for example, a photograph of a product, a product package, or a service, a brand logo, or a diagram or a table representing a product feature. The image is saved in an image format such as, for example, a joint photographic experts group (JPEG) format, a tag image file format (TIFF), or a Portable Network Graphics (PNG).

The behavioral economics determination section 235 determines behavioral economics to be applied. More specifically, the behavioral economics determination section 235 searches for, using the behavioral economics database 232, the behavioral economics corresponding to the advertisement information to determine the behavioral economics to be applied. The behavioral economics represents behavior or decision making of the target for advertising appeal. Thus, it is possible to obtain the behavioral economic relationship between the advertisement information (the purpose and approach of the advertisement) and the behavior or decision making of the target for advertising appeal from the behavioral economics database 232 (Table 1).

In addition, the behavioral economics determination section 235 subjects a known natural language processing algorithm to the purpose of the advertisement acquired by the advertiser purpose input section 210, thereby performing morphological analysis, parsing, semantic analysis, and contextual analysis. Accordingly, the behavioral economics determination section 235 can interpret the text content of the purpose of the advertisement and determine the behavioral economics based on the interpretation result.

The advertisement creation algorithm section 236 receives, from the advertisement design creation section 230, the components such as the catchphrase of the advertisement, the inserted image, and the table, and performs various calculations in the design creation of the advertisement to transmit the calculation result to the advertisement design creation section 230. More specifically, the advertisement creation algorithm section 236 includes an algorithm for calculating the position, size, and the like of each component on the print surface (or the screen or the like) of the advertisement.

The advertisement design physical quantity calculation section 237 generates a physical quantity (index) related to the component of the advertisement. The component may be, for example, the inserted image or the like. In addition, in the present embodiment, the physical quantity may be, for example, at least any of a conspicuous degree and a hue. The conspicuous degree represents a degree of ease of capturing user's visual attention. For example, from the balance or the intensity of contrast of the color combinations and the like on the print surface or the display screen of the inserted image, the conspicuous degree of the inserted image with respect to the entire print surface or the entire display screen may be calculated.

The advertisement design creation section 230 functions as a design information generation section to generates advertisement design information that includes information related to design of the advertisement. More specifically, the advertisement design creation section 230 selects, based on the behavioral economics to be applied and the advertisement information, a catchphrase of the advertisement from a large number of catchphrase candidates stored in the catchphrase database 233. In addition, the advertisement design creation section 230 acquires information related to the screen configuration of the advertisement from the screen configuration database 231 according to the behavioral economics to be applied.

The advertisement design creation section 230 inputs, to the advertisement creation algorithm section 236, the selected catchphrase, the information related to the screen configuration of the advertisement, and the inserted image acquired by the user input section 220 to acquire the calculation result.

Subsequently, the advertisement design creation section 230 generates, based on the calculation result by the advertisement creation algorithm section 236, display layout (for example, information on the position, the size, and the like) of the catchphrase and the inserted image of the advertisement. Then, the advertisement design creation section 230 transmits the advertisement design information including the catchphrase, the image data, and the display layout thereof to the design plan presentation section 240.

Note that in the present embodiment, the advertisement design information includes at least data on the selected catchphrase and the display layout of the catchphrase. In a case where the inserted image is acquired by the user input section 220, the data on the catchphrase and the inserted image, and the display layout for displaying them are included in the advertisement design information.

The design plan presentation section 240 generates an image of the design plan of the advertisement based on the advertisement design information and transmits the image to the display device 160. The display device 160 performs control to display the image of the design plan of the advertisement and the behavioral economics to be applied on the display. The design plan presentation section 240 and the display device 160 function as an output section.

### <Design Creation Support Method>

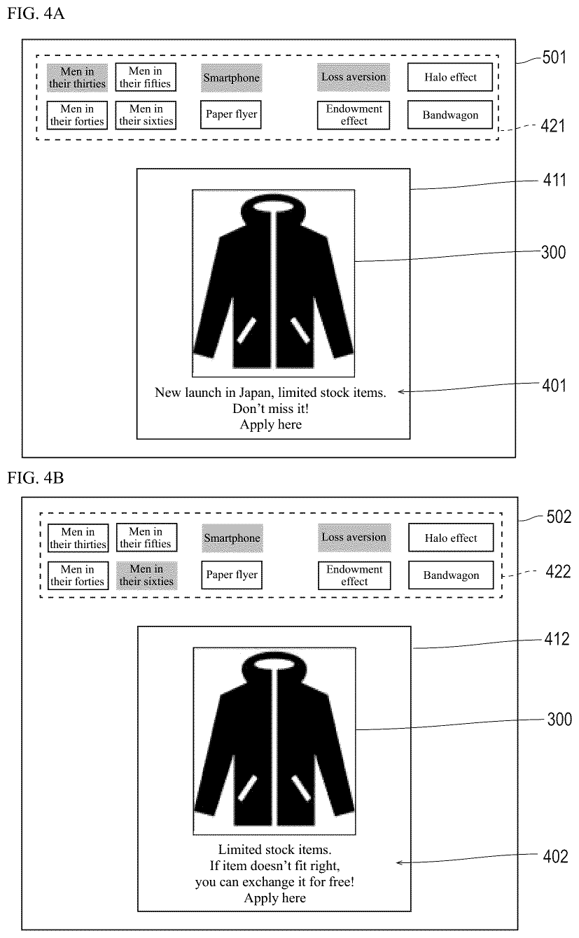

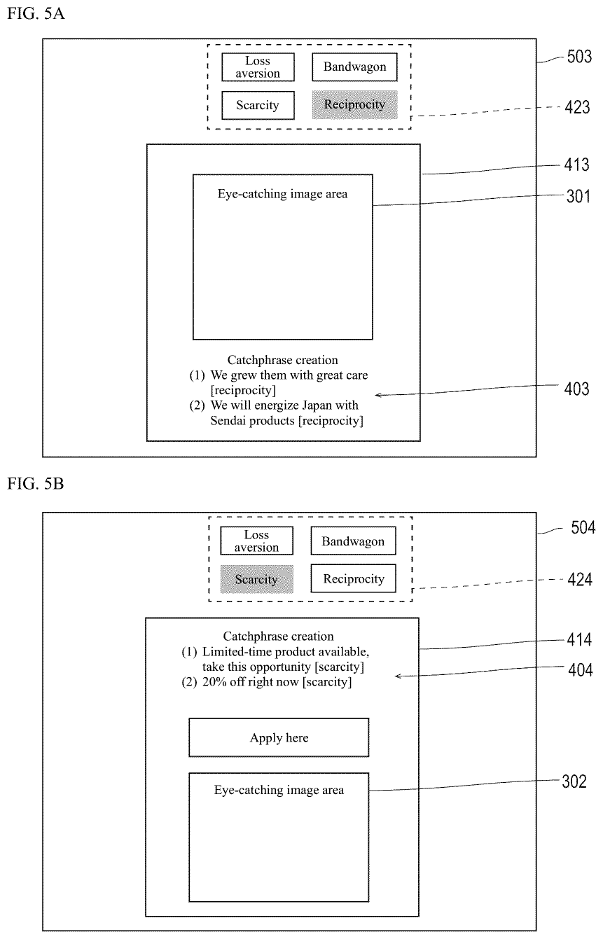

FIG. 3A is a flowchart illustrating a design creation support method of the design creation support apparatus 100 according to the first embodiment, and FIG. 3B is a subroutine flowchart for describing details of step S102 in FIG. 3A. The processing of FIG. 3A and FIG. 3B are implemented by the CPU 110 executing the design creation support program. In addition, FIG. 4A is a schematic diagram illustrating a design plan including a catchphrase for men in their thirties, and FIG. 4B is a schematic diagram illustrating a design plan including a catchphrase for men in their sixties.

In the design creation support method according to the present embodiment, a design plan including the catchphrase of the advertisement is displayed according to the behavioral economics to be applied, and the user changes the advertisement information or the behavioral economics to be applied as necessary, thereby revising the design proposal. By repeating the display and the revision of the design plan, it is possible to obtain the advertisement design (outline) close to an image considered by the user (at the end, the advertiser). The outline of the processing procedure of the design creation support method is as follows.

First, as illustrated in FIG. 3A, the advertisement information including the purpose of the advertisement is acquired (step S101). The input information acquisition section acquires the purpose of the advertisement, the approach of the advertisement, the target audience, the inserted image, and the advertisement medium. For example, a case where the purpose of the advertisement is “Generating New Need” and the approach of the advertisement is “Forcibly Bringing Risk To Mind” is assumed. In addition, the target audiences are men in their thirties and sixties, the inserted image is a clothing image 300 (see FIG. 4A or FIG. 4B), and the advertisement medium is a smartphone.

Next, the advertisement design information is generated (step S102). The advertisement design creation section 230 generates the advertisement design information based on the behavioral economic relationship between the advertisement information and the behavior or decision making of the target for advertising appeal.

More specifically, as illustrated in FIG. 3B, the behavioral economics determination section 235 determines the behavioral economics to be applied according to the advertisement information (for example, the purpose and approach of the advertisement) (step S201). In the example of Table 1, since the purpose of the advertisement is “Generating New Need” and the approach of the advertisement is “Forcibly Bringing Risk To Mind”, the behavioral economics to be applied is determined as “Loss Aversion”.

Alternatively, as described below, it is also possible to select the behavioral economics to be applied based on user input.

Subsequently, the advertisement design creation section 230 selects the catchphrase of the advertisement based on the behavioral economics to be applied and the advertisement information (step S202). In a case where the target audience is men in their thirties, “New Launch In Japan, Limited Stock Items. Don't Miss It!” is selected as the catchphrase, for example. Meanwhile, in a case where the target audience is men in their sixties, “If Item Doesn't Fit Right, You Can Exchange It For Free!” is selected as the catchphrase, for example.

Subsequently, the advertisement creation algorithm section 236 calculates, the position, the size, and the like, on the print surface (screen) of the advertisement, of the catchphrase and the inserted image displayed in the advertisement to transmit the calculation result to the advertisement design creation section 230. The advertisement design creation section 230 generates, based on the calculation result by the advertisement creation algorithm section 236, the display layout of the catchphrase and the inserted image of the advertisement (step S203). The advertisement design creation section 230 transmits the advertisement design information including the data on the catchphrase and the inserted image, and the display layout thereof to the design plan presentation section 240.

Next, returning to FIG. 3A again, the advertisement design information is output (step S103). The design plan presentation section 240 generates, based on the advertisement design information generated by the advertisement design creation section 230 in step S102, the design plan of the advertisement and performs control to display the image of the design plan on the display.

For example, as illustrated in FIG. 4A, in a case where the target audience is men in their thirties, a design plan 411 including the clothing image 300 and a catchphrase 401 (“New Launch In Japan, Limited Stock Items. Don't Miss It!”) is displayed on a screen 501 of the display. Meanwhile, as illustrated in FIG. 4B, in a case where the target audience is men in their sixties, a design plan 412 including the clothing image 300 and a catchphrase 402 (“If Item Doesn't Fit Right, You Can Exchange It For Free!”) is displayed on a screen 502 of the display. Thus, the user can confirm, for each target (persona) audience, the behavioral economics to be applied and the catchphrase of the design plan.

In addition, the design plan presentation section 240 can display the advertisement information acquired by the input information acquisition section, the behavioral economics to be applied, the conspicuous degree (not illustrated) of the clothing image 300, and the like on the screens 501 and 502. For example, in an area indicated by a reference sign 421 in FIG. 4A, a case where the target audience is “Men In Their Thirties”, the advertisement medium is “Smartphone”, and the behavioral economics to be applied is “Loss Aversion” is illustrated. In addition, in an area indicated by a reference sign 422 in FIG. 4B, a case where the target audience is “Men In Their Sixties”, the advertisement medium is “Smartphone”, and the behavioral economics to be applied is “Loss Aversion” is illustrated.

Next, it is determined whether or not change of the advertisement design information is necessary (step S104). In a case where change of the advertisement design information is unnecessary (step S104: NO), the controller 200 ends the processing (END). Meanwhile, in a case where change of the advertisement design information is necessary (step S104: YES), the controller 200 proceeds the processing to step S102.

The user can visually confirm, with respect to the design plan displayed by the design plan presentation section 240, the catchphrase, the advertisement information (for example, the target audience, the advertisement medium, and the like), the display layout, and the behavioral economics to be applied, and can change them as necessary. The controller 200 may receive user input on whether or not change of the advertisement design information is necessary, to determine, based on the input result, whether or not change of the advertisement design information is necessary.

In addition, in a case where change of the advertisement design information is necessary, the controller 200 can receive the change of the behavioral economics to be applied. The controller 200 functions as a background selection section to allows the user to select the behavioral economic background. The user inputs and selects desired behavioral economics through the input device 150, for example. The behavioral economics determination section 235 changes the behavioral economics to be applied based on the user input.

As described above, in the processing in the flowchart illustrated in FIG. 3A, the advertisement information including the purpose of the advertisement is acquired, the advertisement design information is generated based on the behavioral economics background determined according to the advertisement information, and the generated advertisement design information is output. In the processing of generating the advertisement design information illustrated in FIG. 3B, the behavioral economics to be applied is determined according to the advertisement information, and based on the behavioral economics to be applied, the catchphrase of the advertisement is selected. The advertisement design information including the display layout of the catchphrase and the inserted image of the advertisement is generated.

### Modification

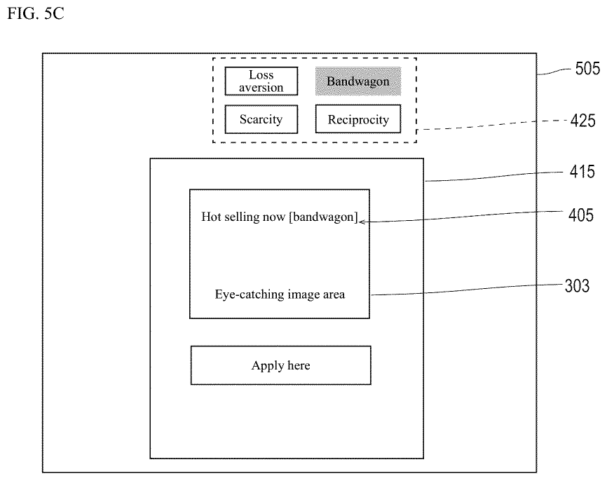

FIG. 5A is a schematic diagram illustrating a design plan in a case where the behavioral economics to be applied is the reciprocity. FIG. 5B is a schematic diagram illustrating a design plan in a case where the behavioral economics to be applied is the scarcity. FIG. 5C is a schematic diagram illustrating a design plan in a case where the behavioral economics to be applied is the bandwagon effect.

Although the case of presenting one catchphrase according to the advertisement information and the behavioral economics to be applied has been described in the above example, a case of presenting one or more catchphrases (candidates) according to the behavioral economics to be applied will be described in the present modification.

Hereinafter, a case of designing an advertisement of a specific agricultural product (for example, ◯◯ strawberries produced in Sendai) will be described as an example. In a case where the behavioral economics to be applied is the reciprocity, the advertisement design creation section 230 selects, for example, “We Grew Them With Great Care” and “We Will Energize Japan With Sendai Products” as the catchphrase. Subsequently, the advertisement design creation section 230 generates the advertisement design information including these catchphrases and the inserted image (not illustrated) of the ◯◯ strawberries.

As illustrated in FIG. 5A, the design plan presentation section 240 displays, on a screen 503, an image of the design plan 413 corresponding to the advertisement design information. In an eye-catching image area 301, the inserted image of the ◯◯ strawberries that attracts the attention of readers of the advertisement is displayed. In addition, “[Reciprocity]” displayed following the end of each catchphrase in the catchphrase candidate list 403 means that the catchphrase is a catchphrase of which the behavioral economics is the reciprocity. In addition, in an area indicated by a reference sign 423 in the screen 503, the behavioral economics to be applied (reciprocity) is displayed in gray.

In addition, the behavioral economics to be applied can also be changed by the user input. For example, as illustrated in FIG. 5B, when the behavioral economics is changed to the scarcity (see an area indicated by a reference sign 424), a catchphrase candidate list 404 including, for example, “Limited-Time Product Available, Take This Opportunity” and “20% Off Right Now” is displayed.

Furthermore, it is also possible to display the catchphrases in the eye-catching image area. In a case where the behavioral economics to be applied is the bandwagon effect, the advertisement design creation section 230 selects, for example, “Hot Selling Now” as the catchphrase. The advertisement design creation section 230 generates the advertisement design information including the catchphrase and the inserted image of the ◯◯ strawberries. As illustrated in FIG. 5C, the design plan presentation section 240 displays, on a screen 505, an image of the design plan 415 corresponding to the advertisement design information. A catchphrase candidate list 405 is displayed within the eye-catching image area 303.

The design creation support apparatus 100, the design creation support method, and the design creation support program of the present embodiment described above have the following effects.

The design creation support apparatus 100 generates and outputs the advertisement design information that includes information related to the advertisement design based on the behavioral economics background determined according to the advertisement information including the purpose of the advertisement. Therefore, it is possible to support advertisement design creation even in a case where the user has little knowledge about advertisement design. More specifically, the design plan presentation section 240 generates the design plan of the advertisement based on the advertisement design information, and the display displays the design plan on the screens 501 to 505. Thus, the user can revise the design plan while visually confirming them.

### Second Embodiment

In the first embodiment, the method for obtaining the outline of the advertisement closer to the image of the advertiser by generating/revising the design plan according to the advertisement information and the behavioral economics to be applied has been described. In the second embodiment, a method for obtaining an outline of an advertisement by performing input of the advertisement information and generation, evaluation, and revision of the design plan via one screen will be described. Hereinafter, in order to avoid duplication of description, detailed description of the same configuration as that of the first embodiment will be omitted.

A controller of the present embodiment functions as an advertiser purpose input section, a user input section, an advertisement design creation section, a screen configuration database, a behavioral economics database, a catchphrase database, and an image database. These respective functions correspond to the advertiser purpose input section 210, the user input section 220, the advertisement design creation section 230, the screen configuration database 231, the behavioral economics database 232, the catchphrase database 233, and the image database 234 in the first embodiment. In addition, the controller functions as a behavioral economics determination section, an advertisement creation algorithm section, an advertisement design physical quantity calculation section, and a design plan presentation section. These respective functions correspond to the behavioral economics determination section 235, the advertisement creation algorithm section 236, the advertisement design physical quantity calculation section 237, and the design plan presentation section 240 in the first embodiment.

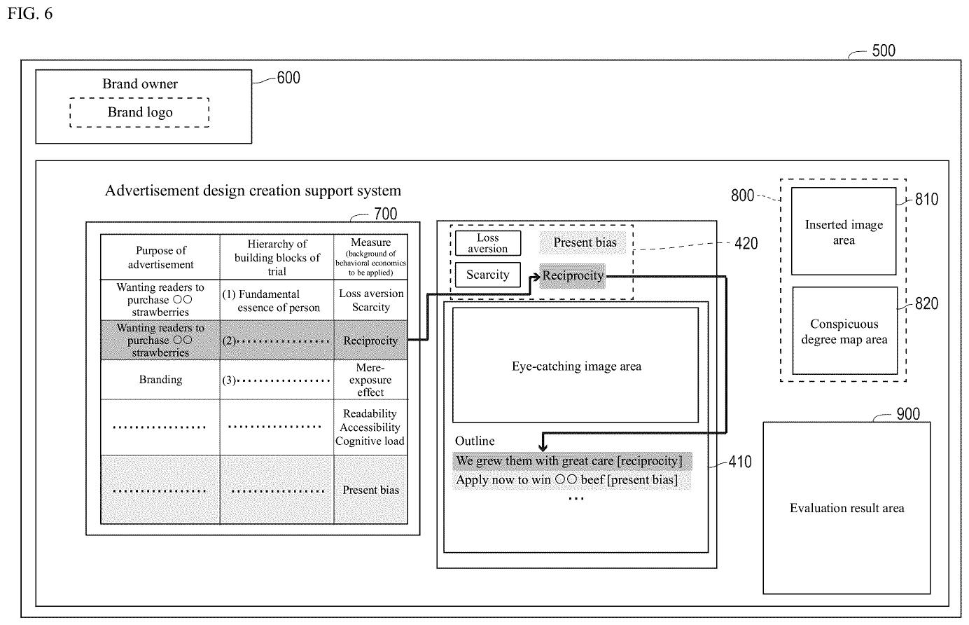

FIG. 6 is a schematic diagram illustrating a screen configuration for performing input of the advertisement information and generation, evaluation, and revision of the design plan via one screen in a design creation support apparatus of a second embodiment.

In the present embodiment, the advertisement design physical quantity calculation section calculates, for example, a physical quantity (index) related to the color combinations of the components in addition to the conspicuous degree of the components and the like. In addition, the design plan presentation section performs control to display, in addition to the display of a design plan 410 and behavioral economics to be applied 420, a brand owner display area 600, a promotion display area 700, a physical quantity display area 800, and an evaluation result display area 900. Note that the design plan presentation section 240 may partially omit the displays or may add other displays.

The design plan 410 corresponds to the design plans 411 to 415 in the first embodiment. In addition, the behavioral economics to be applied 420 corresponds to the area of the behavioral economics to be applied by the reference signs 421 and 422 in FIG. 4A and FIG. 4B and the area of the behavioral economics to be applied by reference signs 423 to 425 in FIG. 5A to FIG. 5C of the first embodiment. In order to avoid duplication of description, detailed description of the design plan 410 and the behavioral economics to be applied 420 will be omitted here.

The brand owner display area 600 is an area for displaying the name of the advertiser, the brand logo, and the like. The name of the advertiser, logo, and the like are displayed at an easily visible position on the upper side of a screen 500, so that the user who creates the design can easily identify the advertiser and the brand.

The promotion display area 700 is an area for displaying promotions and appeal points based on the behavioral economics. For example, a case where the user inputs, as the purpose of the advertisement, “Wanting Readers To Purchase ◯◯ Strawberries” and “Brand” is assumed. For “Wanting Readers To Purchase ◯◯ Strawberries”, the “Reciprocity” corresponds to its measure (behavioral economics to be applied) (see the dark gray part in the drawing).

In addition, for the purpose of the advertisement of “Wanting Readers To Purchase ◯◯ Strawberries”, a plurality of approaches, such as “Fundamental Essence Of Person” and the like can be considered. By stacking a plurality of the approaches for the purpose for each advertisement trial, a hierarchical structure is formed (hierarchy of building blocks of the trial). In addition, in the design plan 410, the reciprocity corresponds to the catchphrase of “We Grew Them With Great Care” (see the arrow in the drawing). In addition, the present bias corresponds to the catchphrase of “Apply Now To Win ◯◯ Beef”.

The physical quantity display area 800 is an area for displaying a physical quantity calculated by the advertisement design physical quantity calculation section. The physical quantity display area 800 includes an inserted image display area 810 and a conspicuous degree map display area 820. The conspicuous degree map display area 820 is an area for displaying a conspicuous degree map (not illustrated) when the inserted image is displayed in the eye-catching image area. The conspicuous degree map is, for example, a graph in which the magnitude of the value of the conspicuous degree corresponding to individual pixels of the inserted image is expressed by a difference in color or color tone, being visualized. The user can evaluate the conspicuous degree of the inserted image in the advertisement by confirming the conspicuous degree map.

The evaluation result display area 900 is an area for displaying the physical quantity (evaluation result) calculated by the advertisement design physical quantity calculation section. The evaluation result may be displayed as, for example, a table or a graph regarding the color combinations of the inserted image, for example. The user can evaluate and verify an effect of the inserted image in the advertisement by confirming the evaluation result.

The design creation support apparatus of the present embodiment described above has the following effects in addition to the effects of the first embodiment.

The individual configurations of the purpose of the advertisement, the catchphrase of the advertisement, the inserted image, the behavioral economics corresponding to the purpose of the advertisement, and the physical quantity are displayed on the identical screen, so that the user can create the design of the advertisement while looking down on these configurations. Thus, a series of processes in the design creation of the advertisement is visualized, and even in a case where the change of the catchphrase, the design, or the like occurs, the visibility is maintained. In addition, these components can also be used as material (evidence) when the user suggests advertisement design to the advertiser.

Furthermore, by using the design creation support apparatus, the user can easily create an advertisement design suitable for the purpose of the advertisement in a short time. Therefore, the design creation support apparatus can be used not only for supporting the design creation of the advertisement by advertising designers or advertising directors, but also for supporting a case where advertisers create advertisement design by themselves.

### Third Embodiment

In the above-described first and second embodiments, the case where the behavioral economics is determined from the purpose of the advertisement based on the correspondence relationship between the purpose of the advertisement and the behavioral economics stored in the behavioral economics database has been described. In the third embodiment, a case where the behavioral economics is determined from the purpose of the advertisement using statistics will be described. Hereinafter, in order to avoid duplication of description, detailed description of the same configuration as that of the first embodiment will be omitted.

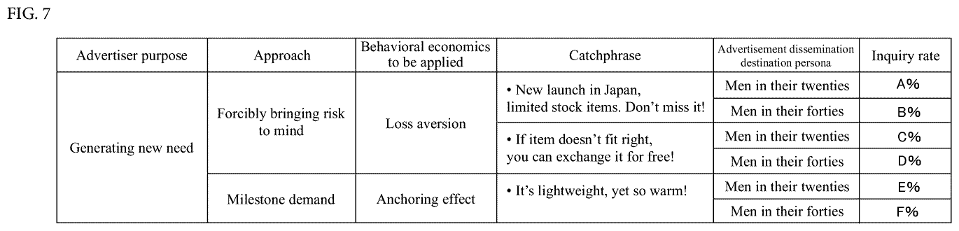

FIG. 7 is a diagram indicating an example of an inquiry rate for each catchphrase of the advertisement and each dissemination destination persona.

A controller of a design creation support apparatus in the present embodiment functions as an advertiser purpose input section, a user input section, an advertisement design creation section, a screen configuration database, a behavioral economics database, a catchphrase database, and an image database. These respective functions correspond to the advertiser purpose input section 210, the user input section 220, the advertisement design creation section 230, the screen configuration database 231, the behavioral economics database 232, the catchphrase database 233, and the image database 234 in the first embodiment. In addition, the controller functions as a behavioral economics determination section, an advertisement creation algorithm section, an advertisement design physical quantity calculation section, and a design plan presentation section. These respective functions correspond to the behavioral economics determination section 235, the advertisement creation algorithm section 236, the advertisement design physical quantity calculation section 237, and the design plan presentation section 240 in the first embodiment.

In the present embodiment, the behavioral economics determination section does not determine the behavioral economics from the correspondence relationship between the purpose of the advertisement and the behavioral economics stored in the behavioral economics database. In the present embodiment, optimal behavioral economics is determined by calculating the posterior probability obtained from Bayes' theorem in statistics.

For example, the candidates of the behavioral economics are set as H₁, H₂, - - - , Hₖ. In addition, a case where the advertisement with these candidates of the behavioral economics is successful is set as A. The behavioral economics determination section calculates, using Bayesian inference, behavioral economics Hᵢ that causes the advertisement to be successful. In some cases, the individual candidates of the behavioral economics H₁, H₂, - - - , Hₖ are cause events that are independent from each other, and in the addition theorem of the probability theory, H₁∪H₂∪ - - - ∪Hₖ is considered never to occur, that is, an empty event. In this case, for the behavioral economics to be applied, the following Expression (1) can be applied as conditional probability in Bayesian inference.

$$P ( {H}_{i} \vert A ) = P ( {H}_{i} ) \cdot P ( A \vert {H}_{i} ) / ( \sum P ( {H}_{i} ) \cdot P ( A \vert {H}_{i} ) ) \qquad ( 1 )$$

Here, P(Hᵢ) is the prior probability of the behavioral economics Hᵢ and P(A|Hᵢ) is the conditional probability of A, which is the case where the advertisement with the behavioral economics Hᵢ is successful. In addition, P(A|Hᵢ) represents the inverse conditional probability of P(A|Hᵢ), that is, the contribution of the behavioral economics Hᵢ in A, which is the case where the advertisement was successful. The behavioral economics determination section determines the behavioral economics to be applied based on calculated values of H₁, H₂, - - - , Hₖ of Expression (1). The above-mentioned Expression (1) can be regarded as the discrete probability distribution. Thus, the behavioral economics determination section may be configured to select Hᵢ having the maximum posterior probability.

For the user or the advertiser, the most important thing is that the advertisement is successful. The above-described “inverse conditional probability” is used as an important index in searching for the cause for achieving the advertisement success.

The advertisement success can be confirmed by, for example, receiving a conversion such as an inquiry rate (or the number of inquiries) from persons who read the advertisement after the advertisement is disseminated to the target audience. The input device 150 and the controller function as a result reception section to receive the conversion of a campaign of the advertisement corresponding to the purpose of the advertisement. In addition, it is considered that the above-mentioned “inverse conditional probability” varies for each target (persona). Thus, it is important to decompose and analyze events for each target.

For example, as illustrated in FIG. 7, in a case where the advertisement dissemination destination person (target audience) is men in their twenties or men in their forties, the inquiry rate is aggregated for each catchphrase. The behavioral economics determination section determines that the higher the inquiry rate as the conversion, the higher the degree of the advertisement success, and determines that the lower the inquiry rate, the lower the degree of the advertisement success.

In addition, in order to search for the possibility of successful behavioral economics, a way of creating an advertisement by intentionally applying the behavioral economics having a very small number of pieces of data and a large variance to confirm the success or failure of the advertisement may be considered.

In addition, in digital advertisement, it is easy to try the candidates of the behavioral economics Hₛ, Hₜ, Hᵤ in combination for different target audiences.

In addition, the behavioral economics determination section of the present embodiment adopts the way of determining the behavioral economics to be applied by inference. Thus, although it is not always possible to determine the optimal behavioral economics, but it is possible to improve the inference accuracy of the behavioral economics to be applied by Bayesian inference. In order to further improve the inference accuracy and increase the probability of the advertisement success, a configuration in which observed data is fed back to the behavioral economics determination section may be included.

Usually, when the advertiser places the advertisement for an event, it is often unknown what kind of advertisement is suitable to capture the consumers mind, and it is assumed that in many cases, the behavioral economics determination section cannot obtain information in advance on what kind of behavioral economics should be applied. In such cases, it can be assumed that the probability (prior probability) that the advertisement is successful due to the behavioral economics to be applied is uniform over the plurality of theories of behavioral economics. Thus, it is possible to adopt a configuration in which the user such as the advertiser or the advertising designer subjectively selects the behavioral economics to be applied, and the input device 150 receives the selected behavioral economics. In addition, it is also possible to adopt a configuration in which priori probability data is prepared in the auxiliary storage device 140 as default and the behavioral economics determination section determines the behavioral economics that is determined to be optimal among the default.

In addition, in a case where the behavioral economics to be applied is determined by Bayesian inference, it is possible to adopt a configuration in which the behavioral economics determination section learns whether or not the placed advertisement is successful. That is, by using the posterior probability, which is the knowledge about the success or failure that is obtained in the first advertisement, as the prior probability at the time of the second advertisement, the behavioral economics to be applied is determined. As described above, the behavioral economics determination section can update, based on the observation data, the probability of success of the campaign of the advertisement in a case of applying a certain behavioral economics.

The behavioral economics determination section advances the learning of the above-described content every time the advertisement is placed and grasps a transition of the posterior probability regarding the success or failure based on the result of the success or failure of the advertisement. Thus, for example, if the probability of the failure of the advertisement increases, the design creation support apparatus can prompt the user to reconsider the policy for the way of placing the advertisement.

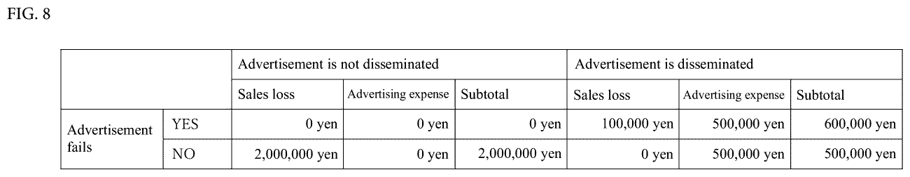

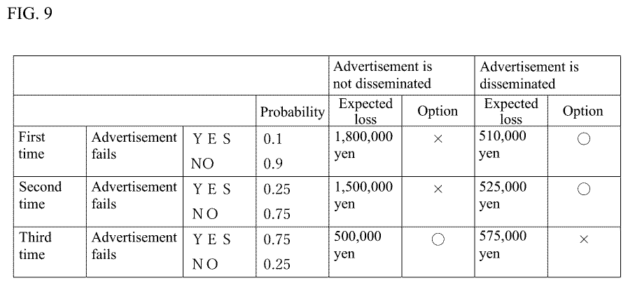

Hereinafter, an example in which the design creation support apparatus determines whether or not to disseminate an advertisement from a viewpoint of the profit and loss based on the result of the success or failure of the advertisement will be described. FIG. 8 is a diagram indicating an example of estimated amounts of advertising expense and sales loss (hereinafter, referred to as “sales loss amount”) in cases where an advertisement is disseminated and is not disseminated. In addition, FIG. 9 is a diagram indicating an example of expected loss amounts and results of determining whether or not to disseminate an advertisement in cases where an advertisement is disseminated and is not disseminated.

As illustrated in FIG. 8, with respect to the sales loss amount, in a case where the advertisement is assumed to fail (YES), if the advertisement is not disseminated, the sales loss amount is 0 yen. On the other hand, in a case where the advertisement is assumed not to fail (NO), that is, the advertisement is assumed to succeed, if the advertisement is not disseminated, the sales loss amount is 2,000,000 yen. Meanwhile, regardless of the success or failure of the advertisement, if the advertisement is not disseminated, there is no advertising expense. In addition, with respect to the sales loss amount, in a case where the advertisement is assumed to fail (YES), if the advertisement is disseminated, the sales loss amount is 100,000 yen. On the other hand, in a case where the advertisement is assumed not to fail (NO), that is, the advertisement is assumed to succeed, if the advertisement is disseminated, the sales loss amount is 0 yen. On the other hand, regardless of the success or failure of the advertisement, if the advertisement is disseminated, the advertising expense is 500,000 yen.

For the first to third advertisements, the posterior probability is assumed as follows. For the first advertisement, the probability that the advertisement fails and the probability that the advertisement succeeds are 0.1 and 0.9, respectively. For the second advertisement, the probability that the advertisement fails and the probability that the advertisement succeeds are 0.25 and 0.75, respectively. For the third advertisement, the probability that the advertisement fails and the probability that the advertisement succeeds are 0.75 and 0.25, respectively.

The controller of the design creation support apparatus calculates the expected loss amount based on the sales loss amount, the advertising expense, and the posterior probability in FIG. 8. The expected loss amount is obtained by the probability that the advertisement fails×the total cost+the probability that the advertisement succeeds×the total cost. Specific calculation results are as follows. The total cost is obtained by the sales loss amount+the advertising expense for each of the cases where the advertisement fails and succeeds.
(1) For the first time
(1-1) Expected loss amount in a case of not disseminating an advertisement: 0.1×0 yen+0.9×2,000,000 yen=1,800,000 yen
(1-2) Expected loss amount in a case of disseminating an advertisement: 0.1×600,000 yen+0.9×500,000 yen=510,000 yen
(2) For the second time
(2-1) Expected loss amount in a case of not disseminating an advertisement: 0.25×0 yen+0.75×2,000,000 yen=1,500,000 yen
(2-2) Expected loss amount in a case of disseminating an advertisement: 0.25×600,000 yen+0.75×500,000 yen=525,000 yen
(3) For the third time
(3-1) Expected loss amount in a case of not disseminating an advertisement: 0.75× 0 yen+0.25×2,000,000 yen=500,000 yen
(3-2) Expected loss amount in a case of disseminating an advertisement: 0.75×600,000 yen+0.25×500,000 yen=575,000 yen

The controller calculates, for each time of the advertisements, the expected loss amount based on the sales loss amount, the advertising expense, and the posterior probability in a case of disseminating an advertisement and in a case of not disseminating an advertisement and determines whether or not to disseminate the advertisement from the viewpoint of the profit and loss according to the calculation result of the expected loss amount. The sales loss amount and the advertising expense in a case of disseminating an advertisement and in a case of not disseminating an advertisement are stored in advance in the auxiliary storage device 140. In the example indicated in FIG. 9, since the expected loss amount in a case of disseminating an advertisement after the third time is larger than the expected loss amount in a case of not disseminating an advertisement, the design creation support apparatus issues a warning before the fourth advertisement is placed.

The design creation support apparatus of the present embodiment described above has the following effects in addition to the effects of the first and second embodiments.

Since the behavioral economics determination section determines the optimal behavioral economics to be applied by Bayesian inference, it is possible to determine the behavioral economics to be applied even for the purpose of the advertisement of which the correspondence relationship with the behavioral economics is not stored in the behavioral economics database. The behavioral economics database is updated according to inference results by a plurality of times of advertisement dissemination.

The present invention is not limited to the above-described embodiments, and various modifications can be made within the scope of the claims.

For example, the design plan presentation section can optionally set display/non-display on a screen of each of the catchphrase of the advertisement, the inserted image, the purpose of the advertisement, the behavioral economics to be applied, and the physical quantity related to components of the advertisement according to a stage or a purpose of design creation.

In addition, it is possible to adopt a configuration in which the result of the success or failure of the advertisement is accumulated in database to be utilized for improving the design plans of the advertisement from the next time by for example, setting the past results of the success or failure as the posterior probability distribution and subjecting Bayesian inference on the conditional prior probability of the display layout of the catchphrase.

Further, an advertisement design support program may be provided by a computer-readable recording medium such as a USB memory, a flexible disk, or a CD-ROM, or may be provided online via a network such as the Internet. In this case, the program recorded on the computer-readable recording medium is usually transferred to and stored in a memory, a storage, or the like. Alternatively, the advertisement design support program may be provided, for example, as single application software, or may be incorporated, as a function of a server, into software of apparatuses.

In addition, a part or a whole of the processing executed by the program in the embodiments may be replaced with hardware such as a circuit to be executed.

This application is based on Japanese Patent Application No. 2021-092732 filed on Jun. 2, 2021, the disclosure of which is incorporated herein by reference in its entirety.

### REFERENCE SIGNS LIST

100 design creation support apparatus
110 CPU
120 RAM
130 ROM
140 auxiliary storage device
150 input device
160 display device
170 communication device
200 controller
210 advertiser purpose input section
220 user input section
230 advertisement design creation section
231 screen configuration database
232 behavioral economics database
233 catchphrase database
234 image database
235 behavioral economics determination section
236 advertisement algorithm section
237 advertisement design physical quantity calculation section
240 design plan presentation section

1. A design creation support apparatus for supporting design creation of a design object including an advertisement or a publication, the design creation support apparatus comprising
a hardware processor that:
acquires input information including a purpose of the design object;
generates design information that includes information related to design of the design object based on a behavioral economic background determined according to the input information; and
outputs the design.

2. The design creation support apparatus according to claim 1, wherein
the hardware processor generates a design plan of the design object based on the design information, and displays the design plan of the design object.

3. The design creation support apparatus according to claim 1, wherein
the hardware processor further acquires, as the input information, at least any of an approach of the design object, a target audience for appeal, an image to be inserted into the design object, and an applied medium.

4. The design creation support apparatus according to claim 3, wherein
the applied medium includes a print medium and a digital medium.

5. The design creation support apparatus according to claim 1, wherein
the behavioral economic background is at least any of bandwagon effect, Zajonc effect, Veblen effect, halo effect, Windsor effect, loss aversion, priming effect, confirmation bias, anchoring effect, status quo bias, endowment effect, scarcity, Zinc pyrithione effect, authority, favor, social proof, consistency, reciprocity, intellectual curiosity, application of affordance, MAYA principle, paradox of choice, undermining, gamification, and prospect theory.

6. The design creation support apparatus according to claim 5, further comprising
a database that stores therein a behavioral economic background corresponding to the purpose of the design object wherein
the hardware processor searches for, using the database, the behavioral economic background corresponding to the purpose of the design object and determines a behavioral economic background to be applied.

7. The design creation support apparatus according to claim 6, wherein
the hardware processor interprets a text content of the purpose of the design object and determines the behavioral economic background to be applied based on an interpretation result.

8. The design creation support apparatus according to claim 6, wherein
hardware processor selects a catchphrase of the design object based on the background that is determined and generates the design information including the catchphrase and display layout of the catchphrase.

9. The design creation support apparatus according to claim 5, wherein
the hardware processor causes a user to select the behavioral economic background that is to be applied,
the hardware processor selects a catchphrase of a design object based on the background that is selected and generates the design information including the catchphrase and display layout of the catchphrase.

10. The design creation support apparatus according to claim 2, wherein
the hardware processor calculates a physical quantity related to display of the design plan.

11. The design creation support apparatus according to claim 10, wherein
the physical quantity includes at least any of a conspicuous degree and a hue.

12. The design creation support apparatus according to claim 10, wherein
the hardware processor generates display layout for displaying, on an identical screen, the purpose of the design object, the catchphrase of the design object, the image to be inserted into the design object, the behavioral economic background corresponding to the purpose of the design object, and the physical quantity, and
displays, on an identical screen, the purpose of the design object, the catchphrase of the design object, the image to be inserted into the design object, the behavioral economic background corresponding to the purpose of the design object, and the physical quantity.

13. The design creation support apparatus according claim 1, wherein
the hardware processor receives a conversion of a campaign of a design object corresponding to the purpose of the design object.

14. A design creation support method for supporting design creation of a design object including an advertisement or a publication, the design creation support method comprising:
a step (a) of acquiring input information including a purpose of the design object;
a step (b) of generating design information that includes information related to design of the design object based on a behavioral economic background determined according to the input information; and
a step (c) of outputting the design information generated in the step (b).

15. A non-transitory recording medium storing a design creation support program for causing a computer to execute processing included in the design creation support method according to claim 14.
